(19) United States
(12) Patent Application Publication
(10) Pub. No.: US 2026/0157368 A1
(43) Pub. Date: Jun. 11, 2026

(54) FILM FORMING COMPOSITION FOR BIOLOGICAL SUBSTRATES

(71) Applicant: MOMENTIVE PERFORMANCE MATERIALS INC., Niskayuna, NY (US)

(72) Inventors: Li Xu, Holmdel, NJ (US); Jeferson Andre Naue, Mahopac, NY (US); Brian Minsik Jun, Pearl River, NY (US)

(21) Appl. No.: 19/410,031

(22) Filed: Dec. 5, 2025

Related U.S. Application Data
(60) Provisional application No. 63/728,751, filed on Dec. 6, 2024.

(51) Int. Cl. A01N 25/24

(52) U.S. Cl. CPC A01N 25/24

(57) ABSTRACT

An oil-ester composition is shown and described herein. The oil-ester composition is suitable as a rainfastening agent for application to an agricultural substrate. The oil-ester composition may be employed in conjunction with agrochemicals to apply agrochemicals to an agricultural substrate. The oil-ester composition exhibits excellent rainfastness to prevent significant run off of an agrochemical upon exposure to water after application to a substrate.

### CROSS-REFERENCE TO RELATED APPLICATIONS

This application claims priority to and the benefit of U.S. Provisional Application No. 63/728,751, titled “FILM FORMING COMPOSITION FOR AGRICULTURAL SUBSTRATES,” filed on Dec. 6, 2024, the disclosure of which is incorporated herein by reference in its entirety.

### FIELD OF INVENTION

The present invention relates to a composition suitable for application to agricultural substrates. In particular, the present invention relates to compositions that exhibit excellent adhesion to agricultural substrates even upon exposure to water to facilitate delivery of agricultural chemicals to agricultural substrates.

### BACKGROUND

Agrochemicals are applied to agricultural substrates, e.g., plants, crops, and the like, for a variety of reasons such as, for example, to provide nutrients to the substrate or protection from pests and diseases. Many agrochemicals work by contact. That is, the agrochemical needs to remain in contact with the agricultural substrate for certain period of time to provide the intended benefit. If rain occurs shortly after treating the agricultural substrates, the agrochemicals can be washed away such that they will not be completely effective in providing the intended benefit (i.e., reduced efficacy). When this happens, the agrochemicals may need to be reapplied to the substrates, which requires additional costs in terms of agrochemical usage. To minimize the risk of treatment loss due to rain, the use of a rainfastening adjuvant, i.e., a product that enhances the ability of the chemicals or biologicals to resist removal or wash-off due to rainfall is recommended.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

In one aspect, provided is an oil-ester composition. The oil-ester composition is suitable as a rainfastening agent for application to an agricultural substrate. The oil-ester composition may be employed in conjunction with agrochemicals to apply agrochemicals to an agricultural substrate. The oil-ester composition exhibits excellent rainfastness to prevent significant run off of an agrochemical upon exposure to water after application to a substrate.

In one aspect, provided is an agricultural oil-ester composition comprising: an oil-ester that is the reaction product of a natural oil having an ethylenically unsaturated portion and a trans-esterification agent in the presence of a catalyst for the esterification of the natural oil, wherein the natural oil is present at a level of 65% to about 98%, the trans-esterification agent at a level of 2% to about 20%, the catalyst is present at a level of 0.01% to 3%, and all percentages are based on the total weight of the oil-ester composition.

In one embodiment, a surfactant in an amount of from about 1% to about 30% based on the total weight of the oil-ester composition.

In one embodiment in accordance with any previous embodiment, the natural oil is selected from bitter gourd, borage, calendula, canola, castor, china wood, coconut, conifer seed, corn, cottonseed, dehydrated castor, flaxseed, grape seed, Jacaranda mimosifolia seed, linseed, olive, palm, palm kernel, peanut, pomegranate seed, rapeseed, safflower, snake gourd, soya(bean), sunflower, tung, wheat germ, or a combination of two or more thereof.

In one embodiment in accordance with any previous embodiment, the trans-esterifying agent is selected from a polyol.

In one embodiment, the polyol is selected from ethylene glycol, diethylene glycol, dipropylene glycol, 1,2-ethanediol, 1,3-propane diol, 1,4-butanediol, 1,6-hexane diol, 1,12-dodecane diol, 3-methyl-1,5-pentane diol, 2,2,4-trimethyl-1,6-hexane diol, 2,2-dimethyl-1,3-propane diol (neopentyl glycol), 2-methyl-2-cyclohexyl-1,3-propane diol or 2-ethyl-2-butyl-1,3-propane diol, 1,2-, 1,3- and 1,4-cyclohexanediols and the corresponding cyclohexane dimethanols, and diols such as alkoxylated bisphenol A products, e.g., ethoxylated or propoxylated bisphenol A; glycerol, pentaerythritol, di-, tri-, and tetrapentaerythritol, neopentyl glycol, sorbitol, trimethylol propane (TMP), trimethylol ethane, di-trimethylol propane, 1,1,1-tris(hydroxymethyl)ethane (TME), bis-TMP, bis-pentaerythritol, sorbitol (1,2,3,4,5,6-hexahydroxyhexane), or a combination of two or more thereof.

In one embodiment in accordance with any previous embodiment, the oil is selected from linseed oil, castor oil, or a combination thereof, and the trans-esterifying agent is selected from pentaerythritol.

In one embodiment in accordance with any previous embodiment, the catalyst is selected from salts of carboxylic acids such as calcium naphthenate, lithium neodecanoate, zinc acetate or metal oxides or hydroxides such as tin oxide, lithium hydroxide, potassium carbonate, potassium hydroxide, or a combination of two or more thereof.

In one embodiment in accordance with any previous embodiment, the catalyst is disposed in mineral oil.

In one embodiment in accordance with any previous embodiment, the agricultural oil-ester composition comprises a photoinitiator.

In one embodiment, the photoinitiator is present in an amount of from about 1 wt. % to about 7.5 wt. % based on the total weight of the agricultural oil-ester composition.

In one embodiment, the photoinitiator is selected from aromatic carbonyl compound, an indoline, a thiazine, a xanthone, a thioxanthone, an oxazine, an arcidine, a phenazine, a coumarin, or a mixture of two or more thereof.

In one embodiment, the photoinitiator is selected from benzophenone, anthraquinone, Rhodamine B, Rhodamine 6G or Violamine R, and also Sulforhodamine B or Sulforhodamine G, malachite green, eosin Y, rose bengal, chlorophyllin, curcumin, benzophenone, 4-phenyl benzophenone, 4-methoxy benzophenone, 4,4′-dimethoxy benzophenone, 4,4′-dimethyl benzophenone, 4,4′-dichlorobenzophenone 4,4′-bis(dimethylamino)benzophenone, 4,4′-bis(diethylamino)benzophenone, 4,4′-bis(methylethylamino)benzophenone, Thioxanthone, 2-isopropylthioxanthone, 2-chlorothioxanthone, 1-chloro-4-propoxythioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, Coumarin 1, Coumarin 2, Coumarin 6, Coumarin 7, Coumarin 30, Coumarin 102, Coumarin 106, Coumarin 138, Coumarin 152, Coumarin 153, Coumarin 307, Coumarin 314, Coumarin 314T, Coumarin 334, Coumarin 337, Coumarin 500, acetophenone, 3-methoxyacetophenone, 4-phenylacetophenone, benzil, 4,4′-bis(dimethylamino)benzil, 2-acetylnaphthalene, 2-naphthaldehyde, dansyl acid derivatives, 9,10-anthraquinone, anthracene, pyrene, aminopyrene, perylene, phenanthrene, phenanthrenequinone, or a combination of two or more thereof.

In another aspect, provided is a rainfastening adjuvant comprising the oil-ester composition of any of the previous aspects or embodiments.

In one embodiment, the rainfastening adjuvant comprises a surfactant.

In one embodiment, the rainfastening adjuvant comprises the oil-ester composition in an amount of from about 20% to about 98% and the surfactant in an amount of from about 2% to about 80% based on the total weight of the adjuvant.

In one embodiment in accordance with any previous embodiment, the surfactant is selected from (i) poly(ethylene glycol)-block-poly(propylene glycol), (ii) alcohol alkoxylate, (iii) silicone polyether, or a combination of two or more thereof.

In one embodiment, the rainfastening adjuvant comprises (a) aromatic solvent or (b) a vegetable oil or (c) a methylated or ethylated vegetable oil and mixtures thereof, and (d) a surfactant or emulsifiers, wherein the agricultural oil-ester composition is present at 10% to 50%, the aromatic solvent, vegetable oil, methylated or ethylated vegetable oil and mixtures thereof are present at 50 to 80%, and the surfactant or emulsifiers are present at 1% to 30%.

In one embodiment, the surfactant or emulsifiers are (i) poly(ethylene glycol)-block-poly(propylene glycol), or (ii) alcohol alkoxylate or (iii) silicone polyether.

In another aspect, provided is a composition comprising (i) an active ingredient, and (ii) an oil-ester composition in accordance with any of the previous aspects or embodiments, or a rainfastening adjuvant in accordance with any of the previous aspects or embodiments.

In one embodiment, the active ingredient is selected from a herbicide, an insecticide, a plant growth regulator, a fungicide, a miticide, an acaricide, a fertilizer, a biocide, a micronutrient, a plant nutritional, a microbial pesticide, a biochemical pesticide, a biostimulant, or a combination of two or more thereof.

In one embodiment, the composition comprises the microbial pesticide, wherein the composition provides the microbial pesticide with protection from ultraviolet radiation.

In one embodiment, the active ingredient is selected from agrochemicals and biologicals, including herbicides, insecticides, plant growth regulators, fungicides, miticides, acaricides, fertilizers, microbial pesticides, biochemical pesticides, biostimulants, plant nutritionals, micronutrients, biocides, or a combination of two or more thereof.

In still another aspect, provided is a method of treating an agricultural substrate comprising applying the composition of any of the previous aspects or embodiments to an agricultural substrate.

In one embodiment, the composition is applied such that the photoinitiator is present in an amount of from about 0.001% to about 0.0075% based on the weight of the rain fastening adjuvant.

In yet another aspect, provided is a method of preparing an oil-ester composition of any of the previous embodiments comprising: (a) providing an oil phase containing a natural oil, a trans-esterification agent and a catalyst; (b) curing the oil phase; wherein the oil-ester composition has a plurality of oil-esters and is formed as a reaction product of the natural oil and the trans-esterification agent in the presence of the catalyst; where the natural oil is present at a level of 85% to 96%, the trans-esterification agent at a level of 4% to 15%, the catalyst is present at a level of 0.01% to 3%, and all percentages are based on the weight of the oil-ester composition.

In one embodiment, the oil-ester has a hydroxyl value of between about 30 and about 250.

In one embodiment, the oil-ester is cured at 150° C. to 250° C.

In one embodiment, the ethylenically unsaturated portion of the oil-ester comprises ethylenically unsaturation from a dry or semi-dry oil or fatty acid.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 shows images of parafilms and glass slides after rainfastness testing of various compositions;

FIG. 2 shows images of parafilms and glass slides after rainfastness testing of various compositions;

FIG. 3 shows images of parafilms and glass slides after rainfastness testing of various compositions;

FIG. 4 shows images of parafilms and glass slides after rainfastness testing of various compositions;

FIGS. 5(a) and 5(b) show images of parafilms before and after rainfastness testing of various compositions;

FIG. 6 shows images of parafilms before and after rainfastness testing of various compositions; and

FIG. 7 shows the UV-VIS spectrum of the composition in solvent.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The term “adjuvant” as used herein includes optional components that impart a functionally useful property to a composition such as, but not limited to, dispensing, wetting, spreading, and the like, and/or enhances a functionally useful property already possessed in some degree by the composition including any composition, material, or substance which increases the efficacy of a bioactive material, agrochemical, and the like to which it is added.

The term “bioactive” refers to an agricultural chemical or material, including but not limited to pesticides, e.g., herbicides, fungicides, insecticides, acaricides and molluscides; plant nutrients; defoliants; and plant growth regulators.

The term “agrochemical,” or “agricultural chemical,” as used herein shall be understood to refer to all bioactive compounds, biological materials including extracts, fractions and by-products thereof, living organisms including microorganisms, and the like, that are suitable for agricultural use such as pesticides, herbicides, fungicides, insecticides, nematocides, larvacides, mitocides, ovacides, plant growth regulators, seed treatment agents, etc.

The term “agricultural substrate” refers to and includes foliar surfaces such as, but not limited to, a plant. Plants may include, but are not limited to, grass, trees, commercial farm crops (such as corn, soybeans, cotton, vegetables, fruit, etc.), weeds, etc. Examples of agricultural substrates include, but are not limited to, vegetable crops such as squash, onion, celery, lettuce, spinach, pumpkin, tomato, eggplant, peppers, broccoli, cabbage, cucumber, and the like; root crops such as potato, beet, carrot, turnip, ginger, sweet potato, and the like; legume crops such as beans, soybeans, peanuts, and the like; cereal grains such as corn, oat, wheat, sorghum, alfalfa, barley, rice, and the like; tree nut crops such as almond, cashew, macadamia, walnut, pecan, pistachioand the like; tree fruits such as apples, pears, peaches, plums, cherries, lemons, oranges, grapefruits, pomelos, limes, and the like; berry crops such as strawberries, raspberries, blueberries, cranberries, blackberries, elderberries; and the like; grapes for production of table grapes, juice, or wine; and turf grasses, lawns, golf courses, ornamental plants, and the like.

The term “agricultural composition” refers to a composition that is applied to plants, weeds, landscapes, grass, trees, pastures, or for other agricultural applications. Agricultural compositions can be provided in concentrated or diluted form. An agricultural composition may or may not contain an agrochemical (agricultural chemical).

“Surfactants” can improve spray deposition properties by reducing the surface tension of the agricultural composition to which they are added, which may be a solution, mixture, dispersion or emulsion and thereby enhance droplet adhesion on foliar surfaces. As used herein, the term surfactant will include emulsifiers, dispersants and spreaders that affect the surface tension of compositions to which they are added.

Provided is a composition suitable for use in conjunction with agrochemical compositions and for application to agricultural substrates. The compositions are suitable for aiding delivery of agrochemicals to agricultural substrates. In particular, the present compositions provide enhanced adhesion to an agricultural substrate. The compositions can function as sticker agents to enhance rainfastness of the agrochemical composition to prevent early run off or wash off of the agrochemical composition upon exposure to water. Thus, the present compositions can aid in delivery of agrochemicals to an agricultural substrate.

The present compositions comprise the reaction product of an unsaturated oil and a trans-esterifying agent. The reaction product of an unsaturated oil and trans-esterifying agent may be referred to herein as an “oil-ester”. A composition of an oil-ester product may be referred to herein as an oil-ester composition.

The unsaturated oil can be selected from a natural oil, a synthetic oil, or fatty acid having an ethylenically unsaturated portion. These materials may also be referred to herein as ethylenically unsaturated oils. The ethylenically unsaturated oil may also include partially hydrogenated natural oils, genetically modified natural oils, and the like.

Examples of suitable ethylenically unsaturated oils include, but are not limited to, natural oils such as, but not limited to, bitter gourd, borage, calendula, canola, castor, china wood, coconut, conifer seed, corn, cottonseed, dehydrated castor, flaxseed, grape seed, Jacaranda mimosifolia seed, linseed, olive, palm, palm kernel, peanut, pomegranate seed, rapeseed, safflower, snake gourd, soya(bean), sunflower, tung, and/or wheat germ; resins such as rosin, synthetic oils such as, but not limited to, distilling tall oil (a by-product of processing pine wood) and/or synthesis (for example by chemical and/or biochemical methods); fatty acids such as, but not limited to, (Z)-hexadan-9-enoic [palmitoleic] acid (C₁₆H₃₀O₂), (Z)-octadecan-9-enoic [oleic] acid (C₁₈H₃₄O₂), (9Z,11E,13E)-octadeca-9,11,13-trienoic [α(alpha)-eleostearic also α-oleostearic]acid (C₁₈H₃₄O₂) (where α-eleostearic acid comprises >65% of the fatty acids of tung oil), licanic acid, (9Z,12Z)-octadeca-9,12-dienoic [linoleic] acid (C₁₈H₃₂O₂), (5Z,8Z,11Z,14Z)-eicosa-5,8,11,14-tetraenoic acid [arachidonic acid](C₂₀H₃₂O₂), 12-hydroxy-(9Z)-octadeca-9-enoic [ricinoleic] acid (C₁₈H₃₄O₃), (Z)-docosan-13-enoic [erucic] acid (C₂₂H₄₂O₂), (Z)-eicosan-9-enoic [gadoleic] acid (C₂₀H₃₈O₂), (7Z,10Z,13Z,16Z,19Z)-docosa-7,10,13,16,19-pentaenoic [clupanodonic] acid; (1R,4aR,4bR,10aR)-1,4α-Dimethyl-7-(propan-2-yl)-1,2,3,4,4a,4b,5,6,10,10α-decahydrophenanthrene-1-carboxylic acid [abietic] acid (C₂₀H₃₀O₂) and/or combinations thereof.

The trans-esterifying agent is selected from an alcohol. Generally, the alcohol will have two or more hydroxy groups (which may also be referred to herein as a polyol). Examples of suitable alcohols as the trans-esterifying agent include, but are not limited to, ethylene glycol, diethylene glycol, dipropylene glycol, 1,2-ethanediol, 1,3-propane diol, 1,4-butanediol, 1,6-hexane diol, 1,12-dodecane diol, 3-methyl-1,5-pentane diol, 2,2,4-trimethyl-1,6-hexane diol, 2,2-dimethyl-1,3-propane diol (neopentyl glycol), 2-methyl-2-cyclohexyl-1,3-propane diol or 2-ethyl-2-butyl-1,3-propane diol, 1,2-, 1,3- and 1,4-cyclohexanediols and the corresponding cyclohexane dimethanols, and diols such as alkoxylated bisphenol A products, e.g., ethoxylated or propoxylated bisphenol A; glycerol, pentaerythritol, di-, tri-, and tetrapentaerythritol, neopentyl glycol, sorbitol, trimethylol propane (TMP), trimethylol ethane, di-trimethylol propane, 1,1,1-tris(hydroxymethyl)ethane (TME), bis-TMP, bis-pentaerythritol, sorbitol (1,2,3,4,5,6-hexahydroxyhexane), combinations of two or more thereof, and the like.

In embodiments, the oil-ester has a hydroxyl (OH) value of from about 20 to about 250, from about 30 to about 225, from about 40 to about 200, from about 50 to about 150, or from about 60 to about 100. Hydroxyl value can be measured according to ASTM D1957-86.

In embodiments, the oil-ester has an acid value of from about 0.1 to about 5.0, from about 0.5 to about 4.0, or from about 1.0 to about 3.0. Acid value may be determined according to ASTM D1980.

The oil-ester is provided by the reaction of the ethylenically unsaturated oil with a polyol in the presence of a catalyst. The oil-ester can be prepared by an oil phase comprising the ethylenically-unsaturated oil, the trans-esterifying agent, and the catalyst, and curing the oil phase under heating. The reaction may be conducted at a temperature of, for example, from about 150° C. to about 250° C., from about 160° C. to about 240° C., or from about 170° C. to about 230° C.

The catalyst for the reaction to form the oil ester is not particularly limited. Examples of suitable catalysts include, but are not limited to, a salt of a carboxylic acid, a metal oxide, a metal hydroxide, a mixture of a carboxylic acid with a salt of a carboxylic acid, and the like.

A salt of a carboxylic acid may comprise a metal and a carboxylate (and may also be referred to herein as a metal carboxylate). In embodiments, the metal is selected from lithium, sodium, calcium, zinc, magnesium, and the like. The carboxylate may be chosen from, but is not limited to, a carboxylate having 3 to 18 carbon atoms. Some examples of suitable salts of carboxylic acids include, but are not limited to, calcium naphthenate, lithium neodecanoate, lithium palmitate, lithium stearate, zinc acetate, sodium acetate, potassium acetate, sodium propionate, calcium propionate, sodium octanoate, calcium benzoate, calcium stearate, sodium oleate, sodium linoleate, potassium oleate, calcium 2-ethylhexoate, calcium acetate, calcium alginate, calcium benzoate, calcium caprate, calcium capr ylate, calcium citrate, calcium gluconate, calcium isodecanoate, calcium isostearate, calcium lact ate, calcium myristate, calcium naphthenate, calcium neodecanoate, calcium oleate, calcium pal mitate, calcium pantothenate, calcium propionate, calcium stearate, calcium stearoyl-2-lactylate, calcium zinc stearate, magnesium 2-ethylhexoate, magnesium caprate, magnesium caprylate, magnesium citrate, magnesium glycerophosphate, magnesium isodecanoate, magnesium lauryl sulfate, magnesium linoleate, magnesium naphthenate, magnesium neodecanoate, magnesium oleate, magnesium palmitate, magnesium ricinoleate, magnesium salicylate, magnesium stearate, zinc stearate, and the like.

The catalyst can also be provided as a mixture of a metal carboxylate and an organic acid. In embodiments, the organic acid is selected from one having 3 to 18 carbon atoms. The organic acid may be a carboxylic acid having 3 to 18 carbon atoms. Examples of suitable organic acids include, but are not limited to, propionic acid, caproic acid, caprylic acid, capric acid, lauric acid, stearic acid, isostearic acid, oleic acid, palmitic acid, linoleic acid, stearic acid caprylic acid, and the like., The ratio of organic acid to metal carboxylate may be about 1:1 to about 4:1, 1:1 to about 3.5:1, 1:1 to about 3:1, 1:1 to about 2.5:1, 1:1 toa bout 2:1, or 1:1 to about 1.5:1. Some examples of such mixtures of organic acids and metal carboxylate include, but are not limited to, a mixture at a ratio of 2.85 parts of isostearic acid (Radiacid 0.909) per 1 part of potassium acetate; a mixture at a ratio of 3.23 parts of hydrogenated dimer lineolic acid (Radiacid 0.975) per 1 part of calcium acetate monohydrate; a mixture at a ratio of 2.87 parts of hydrogenated dimer lineolic acid (Radiacid 0.975) per 1 part of potassium acetate, combinations thereof, and the like.

Examples of metal oxides and metal hydroxides include, but are not limited to, tin oxide, lithium hydroxide, potassium hydroxide, potassium carbonate, potassium bicarbonate, sodium carbonate, sodium bicarbonate, sodium hydroxide, calcium hydroxide, calcium carbonate, and the like.

The catalyst may be disposed in a suitable solvent or carrier such as, for example, in mineral spirit.

In embodiments, the oil-ester is formed from the reaction of a composition comprising an ethylenically-unsaturated oil in an amount of from about 65% to about 98%, from about 70% to about 95%, from about 75% to about 90%, or from about 80% to about 85% by weight based on the total weight of the oil-ester composition.

In embodiments, the oil-ester is formed from the reaction of a composition comprising the trans-esterifying agent in an amount of from about 2% to about 20%, from about 5% to about 18%, from about 8% to about 15%, or from about 10% to about 12% by weight based on the total weight of the oil-ester composition.

The oil-ester composition comprising the reaction product of an ethylenically unsaturated oil and a trans-esterifying agent may have a solid content of about 80% or greater, about 85% or greater, about 90% or greater, or about 95% or greater. In embodiments, the oil-ester composition comprising the reaction product of an ethylenically unsaturated oil and a trans-esterifying agent may have a solid content of from about 80% to about 99%, from about 85% to about 98%, or from about 90% to about 95%.

In embodiments, the oil-ester composition comprises the catalyst in an amount of from 0.01 wt. % to about 1.5 wt. %, from about 0.02 wt. % to about 1.25 wt. %, from about 0.05 wt. % to about 1 wt. %, from about 0.07 wt. % to about 0.7 wt. %, from about 0.1 wt. % to about 0.5 wt. %, or from about 0.2 wt. % to about 0.4 wt. % based on the total weight of the oil-ester composition.

In one embodiment, the oil-ester composition further comprises a surfactant. Suitable surfactants include, but are not limited to, anionic, cationic, nonionic and amphoteric surfactants, block polymers, and polyelectrolytes.

Suitable anionic surfactants include, but are not limited to, alkali metal, alkaline-earth metal or ammonium salts of sulfonates, sulfates, phosphates or carboxylates. Examples of sulfonates are alkylarylsulfonates, diphenylsulfonates, alpha-olefinsulfonates, sulfonates of fatty acids and oils, sulfonates of ethoxylated alkylphenols, condensed naphthaline sulfonates, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants include, but are not limited to, alkoxylates, N-alkylated fatty acid amides, aminoxides, ester-based or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide, preferably ethylene oxide, may be applied for the alkoxylation reaction. Examples of N-alkylated fatty acid amides are fatty acid glucamides or fatty acid alkanolamides. Examples of esters are fatty acid esters, glycerol esters, or monoglycerides. Examples of sugar-based surfactants are sorbitans, ethoxylated sorbitans, sucrose and glucose esters or alkylpolyglucosides. Suitable cationic surfactants are quaternary surfactants, for example quaternary ammonium compounds with one or two hydrophobic groups, or salts of long-chain primary amines. Examples of amphoteric surfactants are alkylbetaines and imidazolines. Suitable block polymers are block polymers of the A-B or of the A-B-A type comprising blocks of polyethylene oxide and polypropylene oxide or of the A-B-C type comprising alkanol, polyethylene oxide and polypropylene oxide. Suitable polyelectrolytes are polyacids or polybases. Examples of polyacids are alkali metal salts of polyacrylic acid. Examples of polybases are polyvinylamines or polyethyleneamines.

Other examples of suitable surfactants include, but are not limited to, alkoxylates, especially ethoxylates, containing block copolymers including copolymers of ethylene oxide, propylene oxide, butylene oxide, and mixtures thereof, alkylarylalkoxylates, especially ethoxylates or propoxylates and their derivatives including alkyl phenol ethoxylate; arylarylalkoxylates, especially ethoxylates or propoxylates. and their derivatives; amine alkoxylates, especially amine ethoxylates; fatty acid alkoxylates; fatty alcohol alkoxylates; guerbet alcohol alkoxylates, alcohol alkyl sulfonates; alkyl benzene and alkyl naphthalene sulfonates; sulfated fatty alcohols, amines or acid amides; acid esters of sodium isethionate; esters of sodium sulfosuccinate; sulfated or sulfonated fatty acid esters; petroleum sulfonates; N-acyl sarcosinates; alkyl polyglycosides; alkyl ethoxylated amines; and the like.

Specific examples include, but are not limited to, alkyl acetylenic diols (SURFONYL—Evonik), 2-ethyl hexyl sulfate, isodecyl alcohol ethoxylates (e.g., RHODASURF DA 530—Solvay), ethylene diamine alkoxylates (TETRONICS—BASF), ethylene oxide/propylene oxide copolymers (PLURONICS—BASF), Gemini type surfactants (Solvay) and diphenyl ether Gemini type surfactants (e.g. DOWFAX—Dow Chemical). Other particularly useful surfactants include, but are not limited to, ethylene oxide/propylene oxide copolymers (EO/PO); amine ethoxylates; alkyl polyglycosides; oxo-tridecyl alcohol ethoxylates, and the like.

Other useful surfactants include organosilicone surfactants including nonionic organosilicone surfactants, e.g., trisiloxane ethoxylate surfactants or a silicone polyether copolymer such as a copolymer of polyalkylene oxide modified heptamethyl trisiloxane and allyloxypolypropylene glycol methylether (commercially available as SILWETR L-77—Momentive Performance Materials).

The surfactant for the oil-ester composition may be provided in an amount of from about 1% to about 30%, from about 5% to about 25%, or from about 10% to about 20% by weight of the total weight of the oil-ester composition.

The oil-ester composition may be employed as part of an adjuvant composition suitable for application to an agricultural substrate. The adjuvant composition comprising the oil-ester composition may also be referred to herein as an agricultural adjuvant or a rainfastening adjuvant.

In embodiments, the adjuvant composition comprises an oil-ester composition and an oil and/or solvent. The present oil-ester compositions are soluble in oils, while many conventional rainfastening agents are not soluble in such materials. In embodiments, the oil can be selected from a vegetable or animal source. In embodiments, the oil can be selected from a vegetable oil, a methylated or ethylated vegetable oil, or mixtures thereof. Examples of suitable oils, include, but not limited to, unsaturated fatty acids, tall oil (e.g., fatty acids of tall oil), phytoblend-based oil, and tallow oil. In embodiments, the adjuvant comprises an oil-ester composition and an ethylenically unsaturated oils such as, but not limited to, natural oils such as, but not limited to, bitter gourd, borage, calendula, canola, castor, china wood, coconut, conifer seed, corn, cottonseed, dehydrated castor, flaxseed, grape seed, Jacaranda mimosifolia seed, linseed, olive, palm, palm kernel, peanut, pomegranate seed, rapeseed, safflower, snake gourd, soya(bean), sunflower, tung, and/or wheat germ. The mixture of the oil-ester and the oil may then be emulsified prior to application.

The adjuvant composition can also include an aromatic solvent. The term “aromatic solvent” refers to a substantially pure compound that is liquid at ambient temperature and that comprises primarily one or more benzene ring moieties. Some non-limiting examples of aromatic solvents include benzene, toluene, xylene, ethyl benzene, mineral spirits, and the like.

In one embodiment, the adjuvant is provided as a concentrate of the oil-ester and a surfactant, emulsifier, or the like. The surfactant may be selected from anionic, cationic, nonionic, and/or amphoteric surfactants, block polymers, and polyelectrolytes such as those described above. In embodiments, the oil-ester composition is present in an amount of from about 20% to about 99%, and the surfactant is present in an amount of from about 1% to about 80% based on the total weight of the adjuvant composition.

In embodiments, the adjuvant composition may comprise a mixture of the oil-ester composition; a solvent or oil selected from an aromatic solvent, a mineral oil, a vegetable oil, and/or a methylated or ethylated vegetable oil; and a surfactant and/or emulsifier. The oil-ester composition may be present in an amount of from about 10% to about 50%, the solvent or oil may be provided in an amount of from about 50% to about 80%, and the surfactant/emulsifier may be present in an amount of from about 1% to about 30% based on the total weight of the adjuvant composition.

The oil-ester composition and/or the adjuvant composition comprising the oil-ester composition may comprise a photoinitiator. Examples of photoinitiators include, but are not limited to, aromatic carbonyl compounds, 3-acylcoumarin derivatives or dyes, indolines, thiazines, xanthones, thioxanthones, oxazines, arcidines, phenazines, coumarins, and the like. Examples of materials suitable as the photoinitiator include, but are not limited to, benzophenone, anthraquinone, Rhodamine B, Rhodamine 6G or Violamine R, and also Sulforhodamine B or Sulforhodamine G, malachite green, eosin Y, rose bengal, chlorophyllin, curcumin, benzophenone, 4-phenyl benzophenone, 4-methoxy benzophenone, 4,4′-dimethoxy benzophenone, 4,4′-dimethyl benzophenone, 4,4′-dichlorobenzophenone 4,4′-bis(dimethylamino)benzophenone, 4,4′-bis(diethylamino)benzophenone, 4,4′-bis(methylethylamino)benzophenone, Thioxanthone, 2-isopropylthioxanthone, 2-chlorothioxanthone, 1-chloro-4-propoxythioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, Coumarin 1, Coumarin 2, Coumarin 6, Coumarin 7, Coumarin 30, Coumarin 102, Coumarin 106, Coumarin 138, Coumarin 152, Coumarin 153, Coumarin 307, Coumarin 314, Coumarin 314T, Coumarin 334, Coumarin 337, Coumarin 500, acetophenone, 3-methoxyacetophenone, 4-phenylacetophenone, benzil, 4,4′-bis(dimethylamino)benzil, 2-acetylnaphthalene, 2-naphthaldehyde, dansyl acid derivatives, 9,10-anthraquinone, anthracene, pyrene, aminopyrene, perylene, phenanthrene, phenanthrenequinone, and the like.

The photoinitiator can be added to the oil-ester composition (i.e., a concentrate of the oil-ester), or it may be added separately to the adjuvant composition (i.e., post mixing of the oil-ester composition with the surfactants, solvents, etc. to form the adjuvant composition). The photoinitiator is generally provided such that it is present in the final adjuvant composition in an amount of from about 0.001% to about 0.0075% based on the weight of the adjuvant composition. Thus, when the photoinitiator is part of the oil-ester composition prior to forming the adjuvant composition, the photoinitiator may be present in an amount of from about 0.1% to about 7.5% based on the weight of the oil-ester composition (concentrate).

In embodiments, the oil-ester composition and oil may be provided as a physical blend with emulsifiers or as an emulsion and be further mixed with an emulsifier. Emulsifiers which may be advantageously employed herein may be readily determined by those skilled in the art and include various nonionic, anionic, cationic and amphoteric emulsifiers, or a blend of two or more emulsifiers. Examn_ples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the propoxylated alkyl phenols, poly(ethylene glycol)-block-poly(propylene glycol) copolymers, and the like. Cationic emulsifiers include quaternary ammonium compounds and fatty amine salts. Anionic emnulsihers include the oil-soluble salts (e.g., calcium) of alkylaryl sulfontic acids, oil-soluble salts or sulfated polyglycol ethers and appropriate salts of phosphated polyglycol ether.

The oil-ester compositions may be employed to facilitate the contact of agrochemicals to agricultural substrates. In particular, the oil-ester compositions have been found to be able to form a film layer and exhibit excellent adhesion to agricultural substrates. Further, the oil-ester compositions have been found to exhibit excellent rainfastness and are not easily washed off of a surface upon exposure to water. Rainfastness according to the present invention is the ability of an active ingredient to remain available on the crop for a longer time when exposed to wet, windy or rainy conditions. In embodiments, rainfastness refers to the ability of a bioactive or agrochemical ingredient to be held on an agricultural substrate (e.g., a leaf, stem, soil, or the like) such that more than 15% of an amount deposited in a thin film on a parafilm substrate may be recovered from the substrate when said substrate is subject to simulated rainfall equivalent to 10 mm in an hour, said simulated rain commencing 120 minutes after application of the substance in conditions of relative humidity of 50% or less.

The oil-ester composition can be employed as part of an agrochemical composition that may be applied to an agricultural substrate. Suitable agrochemical compositions are made by combining, in a manner known in the art, such as, by mixing at least one agrochemical or active ingredient with the present oil-ester compositions, either as a tank-mix, or as an “In-can” formulation.

The term “tank-mix” means the addition of at least one agrochemical to a spray medium, such as water or oil, at the point of use. The tank mix may be prepared, for example, by diluting a dispersion of the oil-ester and at least one agrochemical to a desired concentration such as, but no limited to, the 2-fold to 100-fold, 5-fold to 40-fold, or 10-fold to 20-fold volume. Oils of various types, wetters, adjuvants, and the like may be added to the tank mix or else only immediately prior to preparing the tank mix from the dispersion. These agents can be admixed in a desired ratio weight ratio agent to the dispersion such as, but not limited to, 1:100 to 100:1, 1:50 to 50:1, 1:25 to 25:1, or 1:10 to 10:1.

The term “In-can” refers to a formulation or concentrate containing the oil-ester composition and at least one agrochemical or active ingredient component. The “In-can” formulation may then be diluted to use concentration at the point of use, typically in a Tank-mix, or it may be used undiluted.

The agrochemical employed with the present oil-esters is not particularly limited and can be selected as desired for a particular purpose or intended application. Suitable agrochemical ingredients include, but are not limited to, herbicides, insecticides, plant growth regulators, fungicides, miticides, acaricides, fertilizers, biologicals (i.e., bioherbicides, biofungicides, bioinsecticeds, bioestimulants and bioherbicides), plant nutritionals, micronutrients biocides.paraffinic mineral oil, methylated seed oils (i.e. methylsoyate or methylcanolate), vegetable oils (such as soybean oil and canola oil), water conditioning agents, modified clays, foam control agents, surfactants, wetting agents, dispersants, emulsifiers, deposition aids, antidrift components. In one embodiment, the composition may optionally comprise additional surfactants (co-surfactants). Co-surfactants useful in the compositions herein include nonionic, cationic, anionic, amphoteric, zwitterionic, polymeric surfactants, or any mixture thereof. Surfactants are typically hydrocarbon based or silicone based (i.e. trisiloxane alkoxylate such as Silwet 408, or Silwet 806 to name a few). Moreover, other co-surfactants, that have short chain hydrophobes, such as, but not limited to, those described in U.S. Pat. No. 5,558,806, which is incorporated herein by reference, may also be useful.

The term “pesticide” herein means any compound used to destroy pests, e.g., rodenticides, insecticides, miticides, fungicides, herbicides, and the like. Typical uses for pesticides include agricultural, horticultural, turf, ornamental, home and garden, veterinary and forestry applications. The pesticidal formulations of the present invention also include at least one pesticide. Optionally, the pesticidal formulation may include excipients, cosurfactants, solvents, foam control agents, deposition aids, drift retardants, biologicals, micronutrients, fertilizers, and the like. Illustrative examples of pesticides that can be employed include, but are not limited to mitotic disrupters, lipid biosynthesis inhibitors, cell wall inhibitors, and cell membrane disrupters. The amount of pesticide employed in agrochemical formulations may vary with the type of pesticide employed. More specific examples of pesticide compounds that can be used with the formulations include, but are not limited to, herbicides and plant growth regulators such as phenoxy acetic acids, phenoxy propionic acids, phenoxy butyric acids, benzoic acids, triazines and s-triazines, substituted ureas, uracils, bentazon, desmedipham, methazole, phenmedipham, pyridate, amitrole, clomazone, fluridone, norflurazone, dinitroanilines, isopropalin, oryzalin, pendimethalin, prodiamine, trifluralin, glyphosate, sulfonylureas, imidazolinones, dethodim, diclofop-methyl, fenoxaprop-ethyl, fluazifop-p-butyl, haloxyfop-methyl, quizalofop, sethoxydim, dichlobenil, isoxaben, and bipyridylium compounds.

Fungicide compositions that can be used with the present invention include, but are not limited to, aldimorph, tridemorph, dodemorph, dimethomorph; flusilazol, azaconazole, cyproconazole, epoxiconazole, furconazole, propiconazole, tebuconazole and the like; imazalil, thiophanate, benomyl carbendazim, chlorothialonil; dieloran, trifloxystrobin, fluoxystrobin, dimoxystrobin, azoxystrobin, furcaranil, prochloraz, flusulfamide, famoxadone, captan, maneb, mancozeb, dodicin, dodine, and metalaxyl.

Insecticides, including larvacide, miticide and ovacide compounds that can be used with the composition of the present invention include, but are not limited to, Bacillus thuringiensis, spinosad, abamectin, doramectin, lepimectin, pyrethrins, carbaryl, primicarb, aldicarb, methomyl, amitraz, boric acid, chlordimeform, novaluron, bistrifluron, triflumuron, diflubenzuron, imidacloprid, diazinon, acephate, endosulfan, kelevan, dimethoate, azinphos-ethyl, azinphos-methyl, izoxathion, chlorpyrifos, clofentezine, lambda-cyhalothrin, permethrin, bifenthrin, cypermethrin, and the like.

Fertilizers, and micronutrients include, but are not limited to, zinc sulfate, ferrous sulfate, ammonium sulfate, urea, urea ammonium nitrogen, ammonium thiosulfate, potassium sulfate, monoammonium phosphate, urea phosphate, calcium nitrate, boric acid, potassium and sodium salts of boric acid, phosphoric acid, magnesium hydroxide, manganese carbonate, calcium polysulfide, copper sulfate, manganese sulfate, iron sulfate, calcium sulfate, sodium molybdate, calcium chloride, or a combination of two or more thereof.

Biologicals may include microbial and naturally derived additives that provide protection to a crop or plant. These may include essential oils (botanials), products of bio-fermentation, plant extracts, and the like. Some examples of biologicals include biostimulants, bioinhibitors, biofungicides, bioinsecticides, spinosads, and the like. Biologicals may be provided in any suitable form or from any suitable biological source. In embodiments, biologicals may be derived from microbial products such as, but not limited to, fermentation products (i.e. spinosids), or as microorganisms.

Examples of biostimulants or bioinhibitors, include, but are not limited to, enzymes, proteins, amino acids, micronutrients, salicylic acid, humic and fulvic acids, or protein hydrolases, and the like.

Examples of suitable biofungicides include, but not limited to, Trichoderma (e.g. Trichoderma harzianum), Bacillus subtilis, Bacillus amyloliquefaciens, Bacillus amyloliquefaciens, Bacillus subtilis, Trichoderma harzianum, and Streptomyces lydicus, and the like. One example of a biofungicide is Bacillus amyloliquefaciens strain MBI 600, Serifel® from BASF.

Examples of bioinsecticides include, but not limited to, Bacillus thuringiensis (BT), Burkholderia spp. (e.g. Venerate—Marrone), Chromobacterium subtsugae (e.g. Grandevo—Marrone), Isariafumosorosea, Beauveria bassiana, Metarhizum anisopliae, and the like.

Examples of spinosads include, but are not limited to, Saccharopolyspora spinose, and the like.

Examples of botanicals include, but are not limited to, Pyrethrins, Botanical Oils (e.g. capsicum oleoresin extract, garlic oil, d-limonene, geraniol, cinnamon oil, ginger oil, clove oil, lavender oil, oregano oil, tea tree oil, fennel oil, thyme oil, rosemary oil, neem oil (neem extracts), and the like.

It will be appreciated that biopesticide actives may include, but are not limited to, those listed by EPA at https://www.epa.gov/ingredients-used-pesticide-products/biopesticide-active-ingredients.

Suitable agrochemical compositions are made by combining, in a manner known in the art, such as, by mixing one or more of the above components with the oil-ester composition, either as a tank-mix, or as an “In-can” formulation. The term “tank-mix” means the addition of at least one agrochemical to a spray medium, such as water or oil, at the point of use. The term “In-can” refers to a formulation or concentrate containing the oil-ester composition and at least one agrochemical component. The “In-can” formulation may then be diluted to use concentration at the point of use, typically in a Tank-mix, or it may be used undiluted.

The agrochemical compositions are not limited to use with a particular type of agricultural substrate and can be applied to soil or to various types of crops or vegetation to be intended to be treated with agrochemical composition.

The agrochemical compositions employing the oil-ester compositions, methods of using such compositions, etc., can be employed to treat areas where a variety of crops, plants, etc., may be grown. Examples of suitable crop plants whose production and growth may be enhanced by the use of the present compositions, alone or in conjunction with fertilizers, pesticides, fungicides, etc., include, but are not limited to, nutrients, etc., include, but are not limited to, cereals, for example wheat, rye, barley, triticale, oats, rice, etc.; beet, for example sugar, fodder beet, etc.; pome fruit, stone fruit, and soft fruit, for example apples, pears, plums, peaches, almonds, cherries, strawberries, raspberries, currants, goose-berries, etc.; legumes, for example beans, lentils, peas, lucerne, soybeans, etc.; oil crops, for example oilseed rape, mustard, olives, sunflowers, coconut, cacao, castor beans, oil palm, peanuts, soybeans, etc.; cucurbits, for example pumpkins/squash, cucumbers, melons, etc.; fiber crops, for example cotton, flax, hemp, jute, etc.; citrus fruit, for example oranges, lemons, grapefruit, tangerines, etc.; vegetable plants, for example spinach, lettuce, asparagus, cabbages, carrots, onions, tomatoes, eggplant, potatoes, pumpkin/squash, radish, capsicums, etc.; plants of the laurel family, for example avocados, cinnamon, camphor, etc.; plants of the ginger family, for example, ginger, turmeric, cardamom, galangal, etc.; energy crops and industrial feedstock crops, for example maize, soybeans, wheat, oilseed rape, sugar cane, oil palm, etc.; maize; tobacco; nuts; coffee; tea; bananas; wine (dessert grapes and grapes for vinification); hops; grass, for example turf; sweetleaf (Stevia rebaudania); rubber plants, and forest plants, for example flowers, shrubs, deciduous trees, and coniferous trees, and propagation material, for example seeds, and harvested produce of these plants.

Biologicals, particularly microbial pesticides, can be especially sensitive to exposure to natural ultraviolet (UV) radiation as UV light may damage or inactivate the microbial cells, spores, or proteins that are responsible for pest control. Therefore, exposure to sunlight after application can rapidly decrease the viability and potency of these biological agents, leading to reduced efficacy and shorter residual activity in the field. It will be appreciated that the rainfastness adjuvant also exhibits UV protection properties, as shown from the UV absorption spectra.

Aspects and embodiments of the present technology may be further understood with respect to the following examples. The examples are not intended to be limiting of any particular aspect of the invention.

### EXAMPLES

### Example 1

### Synthesis Of Modified Natural Oil

A modified natural oil with 76 hydroxyl value (OHV) was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. The final product was tested for acid and hydroxyl values. These values were determined following a variation of the ASTM D1957-86 method. The resulting modified natural oil possessed an acid value of 2.67 and a hydroxyl value of 76. A final dispersion was obtained by charging 32 parts of the obtained modified natural oil, 8 parts of Genapol X060 (Isotridecyl alcohol, 6 EO, Clariant) and 60 parts of DI water in a clean dry flask.

### Example 2

A modified natural oil was prepared by mixing 1000 parts of linseed oil and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask. Phase separation was observed in the system after being aged at room temperature for 72 hours, indicating that the mixture system is not stable at room temperature.

### Example 3

A modified natural oil was prepared by mixing 1000 parts of linseed oil, 25 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 4

A modified natural oil was prepared by mixing 1000 parts of linseed oil, 50 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 5

A modified natural oil was prepared by mixing 1000 parts of linseed oil, 150 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 6

A modified natural oil was prepared by mixing 1000 parts of linseed oil, 200 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes, leading to the achievement of a gel system.

### Example 7

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 150° C. under a nitrogen atmosphere and then cured at this temperature for 60 minutes. A separation of solid powder was observed from the liquid phase.

### Example 8

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 175° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 9

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 200° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 10

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 225° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 11

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 275° C. under a nitrogen atmosphere and then cured at this temperature for 60 minutes, leading to the achievement of a gel system.

### Example 12

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 15 minutes. A dispersion was obtained by charging 32 parts of the obtained modified natural oil, 8 parts of the Genapol X060 and 60 parts of DI water in a clean dry flask.

### Example 13

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 30 minutes. A dispersion was obtained by charging 32 parts of the obtained modified natural oil, 8 parts of the Genapol X060 and 60 parts of DI water in a clean dry flask.

### Example 14

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 45 minutes. A dispersion was obtained by charging 32 parts of the obtained modified natural oil, 8 parts of the Genapol X060 and 60 parts of DI water in a clean dry flask.

### Example 15

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 75 minutes. A dispersion was obtained by charging 32 parts of the obtained modified natural oil, 8 parts of the Genapol X060 and 60 parts of DI water in a clean dry flask.

### Example 16

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 90 minutes, leading to the achievement of a gel system.

### Example 17

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 120 minutes, leading to the achievement of a gel system.

### Example 18

A modified natural oil was prepared by mixing 1000 parts of linseed oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 240 minutes, leading to the achievement of a gel system.

### Example 19

A modified natural oil was prepared by mixing 1000 parts of linseed oil and 100 parts of pentaerythritol into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask. Phase separation was observed in the system after being aged at room temperature for 72 hours, indicating that the mixture system is not stable at room.

### Example 20

A modified natural oil was prepared by mixing 1000 parts of linseed oil, 100 parts of pentaerythritol and 0.25 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 21

A modified natural oil was prepared by mixing 1000 parts of linseed oil, 100 parts of pentaerythritol and 0.5 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 22

A modified natural oil was prepared by mixing 1000 parts of linseed oil, 100 parts of pentaerythritol and 0.75 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 23

A modified natural oil was prepared by mixing 1000 parts of linseed oil, 100 parts of pentaerythritol and 1.5 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 24

A modified natural oil was prepared by mixing 1000 parts of linseed oil, 100 parts of pentaerythritol and 2 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes, leading to the achievement of a gel system.

### Example 25

A modified natural oil was prepared by mixing 1000 parts of dehydrated castor oil, 100 parts of pentaerythritol and 1 parts of calcium (4%) naphthenate into a clean dry flask equipped with an agitator, thermometer, nitrogen inlet and outlet. The reaction mixture was stirred and heated to 250° C. under a nitrogen atmosphere and then cured at this temperature for 60 minutes. A dispersion was obtained by charging 32 parts of the obtained modified natural oil, 8 parts of the Genapol X060 and 60 parts of DI water in a clean dry flask.

### Example 26

A modified d-sorbitol linseed oil was prepared by mixing 106 parts of linseed oil, 10 parts of d-sorbitol and 0.2 parts of calcium (4%) naphthenate into a clean dry flask equipped with an agitator, thermometer, nitrogen inlet and outlet. The reaction mixture was stirred and heated to 275° C. under a nitrogen headspace sparging for 2 hours. The resulting modified d-sorbitol linseed oil possessed an acid value of 1.54, a hydroxyl value of 55.92 and a viscosity of 127 cPs.

### Example 27

A modified natural oil with 97 hydroxyl value (OHV) was prepared by mixing 1000 parts of linseed oil, 100 parts of pentaerythritol and 2.65 parts of potassium carbonate into a clean dry flask equipped with an agitator, thermometer, nitrogen inlet and outlet. The reaction mixture was stirred and heated to 190° C. under a nitrogen atmosphere and then cured at this temperature for 120 minutes. The final product was tested for acid and hydroxyl values. These values were determined following a variation of the ASTM D1957-86 method. The resulting modified natural oil possessed an acid value of 0.30 and a hydroxyl value of 97. A final dispersion was obtained by charging 32 parts of the obtained modified natural oil, 8 parts of Genapol X060 (Isotridecyl alcohol, 6 EO, Clariant) and 60 parts of DI water in a clean dry flask.

### Example 28

A modified natural oil with 81 hydroxyl value (OHV) was prepared by mixing 1000 parts of linseed oil, 100 parts of pentaerythritol and 11.2 parts of a mixture of hydrogenated dimer lineolic acid (Radiacid 0.975) and calcium acetate monohydrate (at a ratio of 3.23 parts of Radiacid 0.975 per 1 part of calcium acetate monohydrate) into a clean dry flask equipped with an agitator, thermometer, nitrogen inlet and outlet. The reaction mixture was stirred and heated to 250° C. under a nitrogen atmosphere and then cured at this temperature for 90 minutes. The final product was tested for acid and hydroxyl values. These values were determined following a variation of the ASTM D1957-86 method. The resulting modified natural oil possessed an acid value of 0.46 and a hydroxyl value of 81. A final dispersion was obtained by charging 32 parts of the obtained modified natural oil, 8 parts of Genapol X060 (Isotridecyl alcohol, 6 EO, Clariant) and 60 parts of DI water in a clean dry flask.

### Example 29

A modified natural oil with 68 hydroxyl value (OHV) was prepared by mixing 1000 parts of linseed oil, 100 parts of pentaerythritol and 10 parts of sodium linoleate into a clean dry flask equipped with an agitator, thermometer, nitrogen inlet and outlet. The reaction mixture was stirred and heated to 250° C. under a nitrogen atmosphere and then cured at this temperature for 90 minutes. The final product was tested for acid and hydroxyl values. These values were determined following a variation of the ASTM D1957-86 method. The resulting modified natural oil possessed an acid value of 0.14 and a hydroxyl value of 68. A final dispersion was obtained by charging 32 parts of the obtained modified natural oil, 8 parts of Genapol X060 (Isotridecyl alcohol, 6 EO, Clariant) and 60 parts of DI water in a clean dry flask.

### Example 30

### Comparison Testing

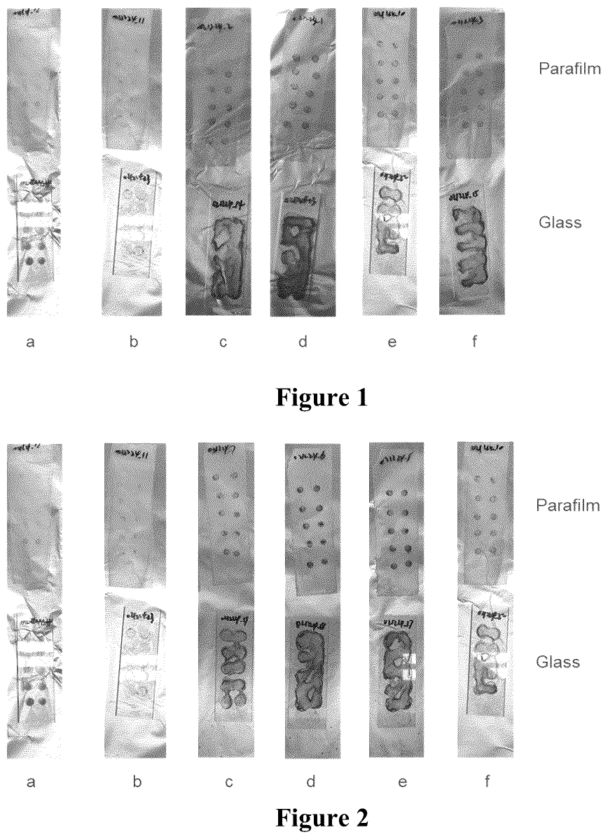

A simulated rain test inspired by AATCC Test Method 22-2005 was used to investigate the rainfastness of the Rhodamine B dye on the substrates. Briefly, 5 drops of 10 microliters of the mixture with 1 wt % Rhodamine B and 0.25 wt % samples from Examples 1, 3, 4, and 5 were dried on 75 mm×25 mm glass slide and 75 mm×25 mm parafilm substrates for three hours, respectively. The substrates were placed at an angle of 45 degree below the spray nozzle, respectively. The spray nozzle was fitted at the bottom of a 155 mm diameter funnel and the distance between the surface of the wafer and the spray nozzle was maintained at 150 mm in all the cases. 125 ml of deionized (“DI”) water (equivalent to 7 mm/second of rainfall) was poured through the funnel and were sprayed on the wafers for a minute. Surfaces of the ambient dried parafilms and glass slide wafers after the washing off were recorded by photography. The concentration of the Rhodamine B in the washed-off water was calculated based on the standard curve of Rhodamine B solutions of known concentrations. In addition, the retention of the dye at surface after washing off (so called rainfastness) was calculated based on the concentration of the dye in the washed-off water. The compositions used as bench mark controls were (i) 1 wt % Rhodamine B aqueous solution without additives (Dye Control), and (ii) 1 wt % Rhodamine B solution mixed with 0.1 wt % of a sticker adjuvant that is an emulsion of latex containing non-ionic surfactant from Momentive Performance Materials (Control Sticker Agent). The results are shown in Table 1 and FIG. 1.

TABLE 1

| | | | Rainfastness | Rainfastness |
|---|---|---|---|---|
| | | | on | on |
| # | Sample | Natural oil:pentaerythritol | parafilm | glass slides |
| 1 | Dye | — | 10.99% | 12.39% |
| | control | | | |
| 2 | Control | — | 13.92% | 25.89% |
| | Sticker | | | |
| | Agent | | | |
| 3 | Example 3 | 10:0.25 | 17.02% | 43.31% |
| 4 | Example 4 | 10:0.5 | 17.91% | 49.85% |
| 5 | Example 1 | 10:1 | 19.11% | 46.77% |
| 6 | Example 5 | 10:1.5 | 26.27% | 47.63% |

FIG. 1 shows images of parafilms and glass slides with (a) dye control, (b) Control Sticker Agent control, (c) Example 3, (d) Example 4, (e) Example 1, and (f) Example 5 after rainfastness test. Table 1 and FIG. 1 show that the rainfastness of Rhodamine B improves with the higher concentration of the alcohol transesterification agent to produce the oil-ester material.

### Example 31

The oil ester composition from Example 26 was tested in a formulation containing 20 wt. % Silwet 819 and 80 wt. % of the d-sorbitol modified oil ester composition. This formulation was dispersed in water at 0.2% concentration and combined with 0.9% of a 1% Rhodamine B solution. Samples of this dispersion were then applied to parafilm coupons using a 10 μL pipette, with eight drops on each coupon, and each sample was tested in triplicate. The parafilm coupons were allowed to air dry overnight, then exposed to a simulated 7 mm of rain event. The eluent was collected and analyzed by UV-Vis spectrophotometry. Rainfastness values were calculated based on the difference between the amount of dye applied and the amount recovered in the eluent. The test showed that 18.2% of the water-soluble dye remained on the treated parafilm surface after the simulated rainfall.

Five drops of 10 microliters of the mixture with 1 wt % Rhodamine B and 0.25 wt % samples from Examples 1, 8, 9, and 10 were dried on 75 mm×25 mm glass slide and 75 mm×25 mm parafilm substrates for two hours, respectively. The substrates were placed at an angle of 45 degree below the spray nozzle, respectively. The spray nozzle was fitted at the bottom of a 155 mm diameter funnel and the distance between the surface of the wafer and the spray nozzle was maintained at 150 mm in all the cases. 125 ml of DI water (equivalent to 7 mm/second of rainfall) was poured through the funnel and were sprayed on the wafers for a minute. Surfaces of the ambient dried parafilms and glass slide wafers after the washing off were recorded by photography. The concentration of the Rhodamine B in the washed-off water was calculated based on the standard curve of Rhodamine B solutions of known concentrations. In addition, the retention of the dye at surface after washing off (so called rainfastness) was calculated based on the concentration of the dye in the washed-off water. The compositions used as benchmark controls were (i) 1 wt % Rhodamine B aqueous solution without additives (Dye Control), and (ii) 1 wt % Rhodamine B solution mixed with 0.1 wt % of a sticker adjuvant that is an emulsion of latex containing non-ionic surfactant from Momentive Performance Materials (Control Sticker Agent). The results are shown in Table 2 and FIG. 2.

### Example 32

TABLE 2

| | | Curing | | |
|---|---|---|---|---|
| | | temperature | Rainfastness on | Rainfastness on |
| # | Sample | (° C.) | parafilm | glass slides |
| 1 | Dye control | — | 5.40% | 6.88% |
| 2 | Control Sticker | — | 8.51% | 21.23% |
| | Agent | | | |
| 3 | Example 8 | 175 | 10.09% | 29.34% |
| 4 | Example 9 | 200 | 15.65% | 38.26% |
| 5 | Example 10 | 225 | 18.07% | 43.03% |
| 6 | Example 1 | 250 | 12.77% | 43.43% |

FIG. 2 shows images of parafilms and glass slides with (a) dye control, (b) Control Sticker Agent control, (c) Example 8, (d) Example 9, (e) Example 10, and (f) Example 1 after rainfastness test. The examples in accordance with the present technology all show improved rainfastness compared to the control samples. The data show that curing the oil-ester composition at higher temperatures may enhance the rainfastness of the oil-ester composition.

### Example 31

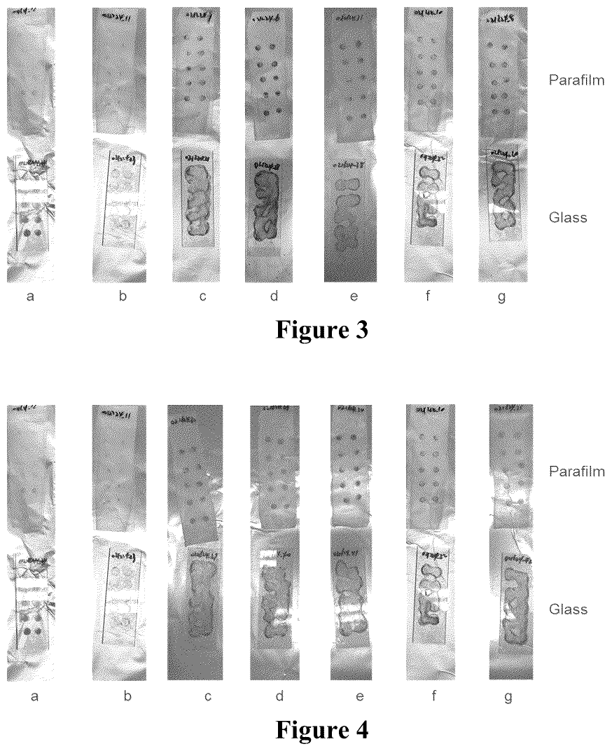

Five drops of 10 microliters of the mixture with 1 wt % Rhodamine B and 0.25 wt % samples from Examples 1, 12, 13, 14, and 15 were dried on 75 mm×25 mm glass slide and 75 mm×25 mm parafilm substrates for two hours, respectively. The substrates were placed at an angle of 45 degree below the spray nozzle, respectively. The spray nozzle was fitted at the bottom of a 155 mm diameter funnel and the distance between the surface of the wafer and the spray nozzle was maintained at 150 mm in all the cases. 125 ml of DI water (equivalent to 7 mm/second of rainfall) was poured through the funnel and sprayed on the wafers for a minute. Surfaces of the ambient dried parafilm and glass slide wafers after the washing off were recorded by photography. The concentration of Rhodamine B in the washed-off water was calculated based on the standard curve of Rhodamine B solutions of known concentrations. In addition, the retention of the dye at surface after washing off (so called rainfastness) was calculated based on the concentration of the dye in the washed-off water. The compositions used as bench mark controls were (i) 1 wt % Rhodamine B aqueous solution without additives (Dye Control), and (ii) 1 wt % Rhodamine B solution mixed with 0.1 wt % of a sticker adjuvant that is an emulsion of latex containing non-ionic surfactant from Momentive Performance Materials (Control Sticker Agent) The results are shown in Table 3 and FIG. 3.

TABLE 3

| | | Curing | Rainfastness | Rainfastness |
|---|---|---|---|---|
| | | time | on | on |
| # | Sample | (hours) | parafilm | glass slides |
| 1 | Dye control | — | 5.40% | 6.88% |
| 2 | Control Sticker | — | 8.51% | 21.23% |
| | Agent | | | |
| 3 | Example 12 | 0.25 | 6.84% | 26.19% |
| 4 | Example 13 | 0.50 | 13.18% | 40.62% |
| 5 | Example 14 | 0.75 | 15.15% | 37.69% |
| 6 | Example 1 | 1.00 | 12.77% | 43.43% |
| 7 | Example 15 | 1.25 | 8.75% | 29.83% |

FIG. 3 shows images of parafilm and glass slides with (a) dye control, (b) Control Sticker Agent, (c) Example 12, (d) Example 13, (e) Example 14, (f) Example 1, and (g) Example 15 after rainfastness test. Based on Table 3 and FIG. 3, it indicates that the rainfastness of Rhodamine B is enhanced with the present oil-ester materials. Further, rainfastness can be improved further by adjusting the curing time during the natural oil-ester preparation process.

### Example 32

Five drops of 10 microliters of the mixture with 1 wt % Rhodamine B and 0.25 wt % samples from Examples 1, 20, 21, 22, and 23 were dried on 75 mm×25 mm glass slide and 75 mm×25 mm parafilm substrates for two hours, respectively. The substrates were placed at an angle of 45 degree below the spray nozzle, respectively. The spray nozzle was fitted at the bottom of a 155 mm diameter funnel and the distance between the surface of the wafer and the spray nozzle was maintained at 150 mm in all the cases. 125 ml of DI water (equivalent to 7 mm/second of rainfall) was poured through the funnel and sprayed on the wafers for a minute. Surfaces of the ambient dried parafilm and glass slide wafers after the washing off were recorded by photography. The concentration of Rhodamine B in the washed-off water was calculated based on the standard curve of Rhodamine B solutions of known concentrations. In addition, the retention of the dye at surface after washing off (so called rainfastness) was calculated based on the concentration of the dye in the washed-off water. The compositions used as benchmark controls were (i) 1 wt % Rhodamine B aqueous solution without additives (Dye Control), and (ii) 1 wt % Rhodamine B solution mixed with 0.1 wt % of a sticker adjuvant that is an emulsion of latex containing non-ionic surfactant from Momentive Performance Materials (Control Sticker Agent). The results are shown in Table 4 and FIG. 4.

TABLE 4

| | | Catalyst | | |
|---|---|---|---|---|
| | | amount | Rainfastness on | Rainfastness on |
| # | Sample | (part) | parafilm | glass slides |
| 1 | Dye control | — | 5.40% | 6.88% |
| 2 | Control Sticker | — | 8.51% | 21.23% |
| | Agent | | | |
| 3 | Example 20 | 0.25 | 21.02% | 35.32% |
| 4 | Example 21 | 0.50 | 18.56% | 33.25% |
| 5 | Example 22 | 0.75 | 21.49% | 36.28% |
| 6 | Example 1 | 1.00 | 16.62% | 39.91% |
| 7 | Example 23 | 1.50 | 17.84% | 39.17% |

FIG. 4 shows images of parafilm and glass slides with (a) dye control, (b) Control Sticker Agent, (c) Example 20, (d) Example 21, (e) Example 22, (f) Example 1, and (g) Example 23 after rainfastness test. Table 4 and FIG. 4 show that the present oil-ester compositions provide excellent rainfastness. Table 4 and FIG. 4 also show that rainfastness of can be enhanced by controlling the amount of catalyst employed during the natural oil-ester preparation process.

### Example 33

Twelve to sixteen drops of 10 microliters of the mixture with 1 wt % Dipel (Bacillus thuringiensis) and 0.1 wt % samples from Table 5 were deposited on parafilm strips. Tests #3-#6 were mixed with the product from Example 1 or Example 27 with the specified emulsifier at a mass ratio of 4:1 product:emulsifier. The parafilm strips of #1-#5 were first dried in darkness for 2 to 24 h at room temperature, and then placed in Q-Sun xenon test chamber (420 nm, 42° C. chamber air temperature) for 120 minutes. Afterwards, the substrates were placed at an angle of 45 degree below the spray nozzle, respectively. The spray nozzle was fitted at the bottom of a 155 mm diameter funnel and the distance between the surface of the wafer and the spray nozzle was maintained at 150 mm in all the cases. 125 mL of DI water (equivalent to 7 mm/second of rainfall) was poured through the funnel and sprayed on the wafers for two minutes. Surfaces of the ambient dried parafilm slides after the washing off were recorded by photography. The rainfastness was calculated by measuring the mass of the parafilm alone, the mass of the parafilm after deposition and drying, and mass of the parafilm after the water treatment. The calculated rainfastness value is the amount of mass remaining after the wash.

TABLE 5

| # | Sample | Emulsifier | Rainfastness on parafilm |
|---|---|---|---|
| 1 | Without | — | 0% |
| | adjuvant | | |
| 2 | Control sticker | — | 23.0% |
| | agent | | |
| 3 | Example 1 | Silwet 408 | 16.9% |
| 4 | Example 1 | Genapol X 060 | 17.5% |
| 5 | Example 27 | Silwet 408 | 20.5% |

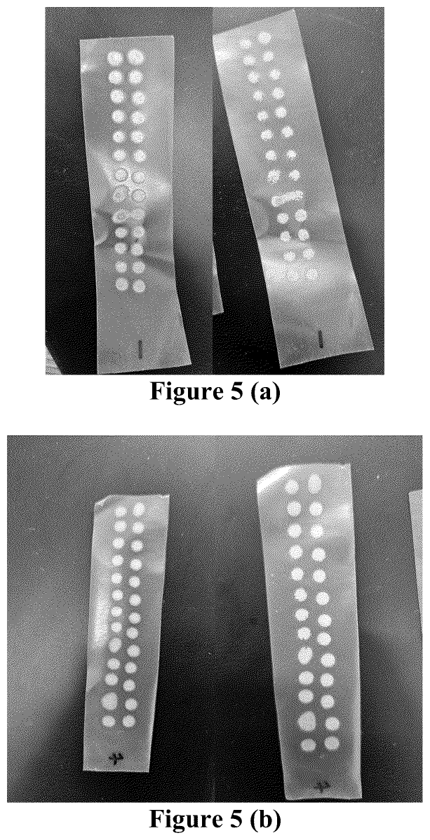

FIG. 5 shows images of parafilm slides with (a) #2 and (b) #3. Images before wash are on the left, and images after wash are on the right.

### Example 34

Twelve to sixteen drops of 10 microliters of the mixture with 1 wt % Dipel (Bacillus thuringiensis) and 0.1 wt % samples from Table 6 were deposited on parafilm strips. Tests #1-#3 were mixed with the product from Example 1 with the Genapol X 060 emulsifier specified at a mass ratio of 4:1 product:emulsifier. To the formulations were added the photoinitiator chlorophyllin at the specified mass percentages. The parafilm strips were first dried in darkness from 2 to 24 h, and then placed in Q-Sun xenon test chamber (420 nm, 42° C. chamber air temperature) for 120 minutes. Afterwards, the substrates were placed at an angle of 45 degree below the spray nozzle, respectively. The spray nozzle was fitted at the bottom of a 155 mm diameter funnel and the distance between the surface of the wafer and the spray nozzle was maintained at 150 mm in all the cases. 125 mL of DI water (equivalent to 7 mm/second of rainfall) was poured through the funnel and sprayed on the wafers for two minutes. Surfaces of the ambient dried parafilm slides after the washing off were recorded by photography. The rainfastness was calculated by measuring the mass of the parafilm alone, the mass of the parafilm after deposition and drying, and mass of the parafilm after the water treatment. The calculated rainfastness value is the amount of mass remaining after the wash.

TABLE 6

| | | Photoinitiator | |
|---|---|---|---|
| # | Sample | amount | Rainfastness on parafilm |
| 1 | Example 1 | 0% | 17.5% |
| 2 | Example 1 with | 0.0012% | 24.9% |
| | chlorophyllin | | |
| 3 | Example 1 with | 0.0054% | 30.6% |
| | chlorophyllin | | |

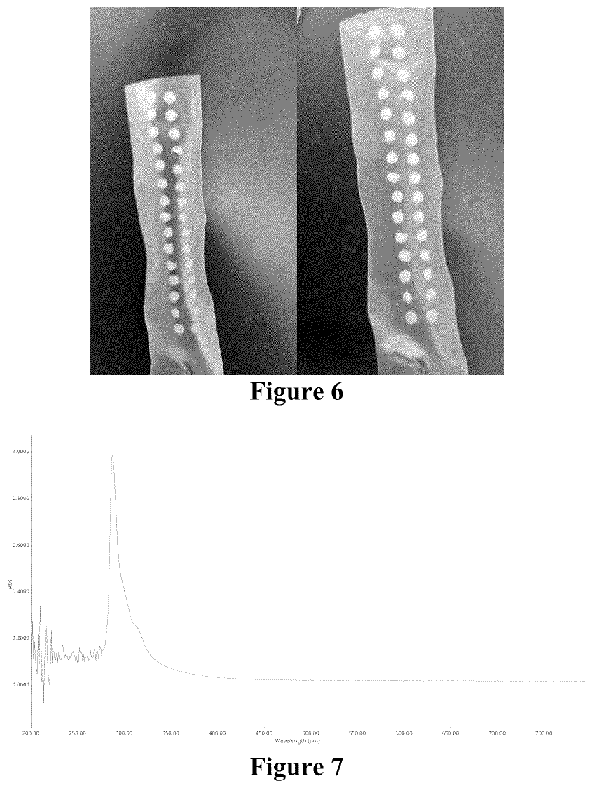

FIG. 6 shows images of parafilm slides with #2. Image before wash is on the left, and image after wash is on the right. Table 6 and FIG. 6 also show that rainfastness can be enhanced by controlling the amount of photoinitiator added.

FIG. 7 shows the UV/VIS spectrum from the product in example #35.

### Example 35

A mixture of 1.28% of the product from Example 1 was prepared in isopropyl alcohol. This mixture was analyzed by UV-vis spectroscopy. The extinction coefficient value (mass of sample per mass of solvent) at the wavelength of 350 nm was calculated as 5.47 g/g cm, and the extinction coefficient value at the wavelength of 288 nm was calculated as 76.9 g/g cm.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an oil-ester, compositions comprising the same including agrochemical compositions, and methods of treating agricultural substrates with such materials and compositions. Modifications may occur to those skilled in the art and to those who may make and use the invention. The disclosed embodiments are merely for illustrative purposes and not intended to limit the scope of the invention or the subject matter set forth in the claims.

What is claimed is:

1. An agricultural oil-ester composition comprising: an oil-ester that is the reaction product of a natural oil having an ethylenically unsaturated portion and a trans-esterification agent in the presence of a catalyst for the esterification of the natural oil, wherein the natural oil is present at a level of 65% to about 98%, the trans-esterification agent at a level of 2% to about 20%, the catalyst is present at a level of 0.01% to 3%, and all percentages are based on the total weight of the oil-ester composition.

2. The agricultural oil-ester composition of claim 1 comprising a surfactant in an amount of from about 1% to about 30% based on the total weight of the oil-ester composition.

3. The agricultural oil-ester composition of claim 1, wherein the natural oil is selected from bitter gourd, borage, calendula, canola, castor, china wood, coconut, conifer seed, corn, cottonseed, dehydrated castor, flaxseed, grape seed, Jacaranda mimosifolia seed, linseed, olive, palm, palm kernel, peanut, pomegranate seed, rapeseed, safflower, snake gourd, soya(bean), sunflower, tung, wheat germ, or a combination of two or more thereof.

4. The agricultural oil-ester composition of any of claim 1, wherein the trans-esterifying agent is selected from a polyol.

5. The agricultural oil-ester composition of claim 4, wherein the polyol is selected from ethylene glycol, diethylene glycol, dipropylene glycol, 1,2-ethanediol, 1,3-propane diol, 1,4-butanediol, 1,6-hexane diol, 1,12-dodecane diol, 3-methyl-1,5-pentane diol, 2,2,4-trimethyl-1,6-hexane diol, 2,2-dimethyl-1,3-propane diol (neopentyl glycol), 2-methyl-2-cyclohexyl-1,3-propane diol or 2-ethyl-2-butyl-1,3-propane diol, 2,2-bis(hydroxymethyl)-1,3-propanediol (pentaerythritol), 1,2-, 1,3- and 1,4-cyclohexanediols and the corresponding cyclohexane dimethanols, and diols such as alkoxylated bisphenol A products, glycerol, pentaerythritol, di-, tri- and tetrapentaerythritol, neopentyl glycol, sorbitol, trimethylol propane (TMP), trimethylol ethane, di-trimethylol propane, 1,1,1-tris(hydroxymethyl)ethane (TME), bis-TMP, bis-pentaerythritol, sorbitol (1,2,3,4,5,6-hexahydroxyhexane), or a combination of two or more thereof.

6. The agricultural oil-ester composition of claim 1, wherein the oil is selected from linseed oil, castor oil, or a combination thereof, and the trans-esterifying agent is selected from pentaerythritol.

7. The agricultural oil-ester composition of claim 1, wherein the catalyst is selected from salts of carboxylic acids, calcium naphthenate, lithium neodecanoate, zinc acetate, tin oxide, lithium hydroxide, potassium hydroxide, or a combination of two or more thereof.

8. The agricultural oil-ester composition of claim 1, wherein the catalyst is disposed in a mineral oil.

9. The agricultural oil-ester composition of claim 1 comprising a photoinitiator.

10. The agricultural oil-ester composition of claim 9, wherein the photoinitiator is present in an amount of from about 1 wt. % to about 7.5 wt. % based on the total weight of the agricultural oil-ester composition.

11. The agricultural oil-ester composition of claim 9, wherein the photoinitiator is selected from aromatic carbonyl compound, an indoline, a thiazine, a xanthone, a thioxanthone, an oxazine, an arcidine, a phenazine, a coumarin, or a mixture of two or more thereof.

12. The agricultural oil-ester composition of claim 9, wherein the photoinitiator is selected from benzophenone, anthraquinone, Rhodamine B, Rhodamine 6G or Violamine R, and also Sulforhodamine B or Sulforhodamine G, malachite green, eosin Y, rose bengal, chlorophyllin, curcumin, benzophenone, 4-phenyl benzophenone, 4-methoxy benzophenone, 4,4′-dimethoxy benzophenone, 4,4′-dimethyl benzophenone, 4,4′-dichlorobenzophenone 4,4′-bis(dimethylamino)benzophenone, 4,4′-bis(diethylamino)benzophenone, 4,4′-bis(methylethylamino)benzophenone, Thioxanthone, 2-isopropylthioxanthone, 2-chlorothioxanthone, 1-chloro-4-propoxythioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, Coumarin 1, Coumarin 2, Coumarin 6, Coumarin 7, Coumarin 30, Coumarin 102, Coumarin 106, Coumarin 138, Coumarin 152, Coumarin 153, Coumarin 307, Coumarin 314, Coumarin 314T, Coumarin 334, Coumarin 337, Coumarin 500, acetophenone, 3-methoxyacetophenone, 4-phenylacetophenone, benzil, 4,4′-bis(dimethylamino)benzil, 2-acetylnaphthalene, 2-naphthaldehyde, dansyl acid derivatives, 9,10-anthraquinone, anthracene, pyrene, aminopyrene, perylene, phenanthrene, phenanthrenequinone, or a combination of two or more thereof.

13. A rainfastening adjuvant comprising the agricultural oil-ester composition of any of claim 1.

14. The rainfastening adjuvant of claim 13 comprising a surfactant.

15. The rainfastening adjuvant of claim 14 comprising the oil-ester composition in an amount of from about 20% to about 98% and the surfactant in an amount of from about 2% to about 80% based on the total weight of the adjuvant.

16. The rainfastening adjuvant of claim 14, wherein the surfactant is selected from (i) poly(ethylene glycol)-block-poly(propylene glycol), (ii) alcohol alkoxylate, (iii) silicone polyether, or a combination of two or more thereof.

17. The rainfastening adjuvant of claim 13 comprising (a) mineral oil or (b) aromatic solvent or (c) a vegetable oil or (d) a methylated or ethylated vegetable oil and mixtures thereof, and (d) a surfactant or emulsifiers, wherein the composition of claim 1 is present at 10% to 50%, the mineral oil, aromatic solvent, vegetable oil, methylated or ethylated vegetable oil and mixtures thereof are present at 50 to 80%, and the surfactant or emulsifiers are present at 1% to 30%.

18. The rainfastening adjuvant of claim 17, wherein the surfactant or emulsifiers are (i) poly(ethylene glycol)-block-poly(propylene glycol), or (ii) alcohol alkoxylate or (iii) silicone polyether.

19. A composition comprising (i) an agrochemical, and (ii) an oil-ester composition of claim 1.

20. The composition of claim 20, wherein the agrochemical is selected from a herbicide, an insecticide, a plant growth regulator, a fungicide, a miticide, an acaricide, a fertilizer, a biocide, a micronutrient, a plant nutritional, a microbial pesticide, a biochemical pesticide, a biostimulant, or a combination of two or more thereof.

21. The composition of claim 20 comprising the microbial pesticide, wherein the composition provides the microbial pesticide with protection from ultraviolet radiation.

22. A method of treating an agricultural substrate comprising applying the composition of claim 19 to an agricultural substrate.

23. The method of claim 22, comprising a photoinitiator, wherein the composition is applied such that the photoinitiator is present in an amount of from about 0.001% to about 0.0075% based on the weight of the rain fastening adjuvant.

24. A method of preparing an oil-ester composition of claim 1 comprising: (a) providing an oil phase containing a natural oil, a trans-esterification agent and a catalyst; (b) curing the oil phase; wherein the oil-ester composition has a plurality of oil-esters and is formed as a reaction product of the natural oil and the trans-esterification agent in the presence of the catalyst; where the natural oil is present at a level of 88% to 96%, the trans-esterification agent at a level of 4% to 12%, the catalyst is present at a level of 0.01% to 3%, and all percentages are based on the weight of the oil-ester composition.

25. The method of claim 24, wherein the oil-ester has a hydroxyl value of between about 30 and about 250.

26. The method of claim 24, wherein the oil-ester is cured at 150° C. to 250° C.

27. The method of claim 24, wherein the ethylenically unsaturated portion of the oil-ester comprises ethylenically unsaturation from a dry or semi-dry oil or fatty acid.
